(19) United States
(12) Patent Application Publication
(10) Pub. No.: US 2023/0016190 A1
(43) Pub. Date: Jan. 19, 2023

(54) PACKAGE DELIVERY DOOR

(71) Applicant: Robert Safstrom, San Antonio, TX (US)

(72) Inventor: Robert Safstrom, San Antonio, TX (US)

(21) Appl. No.: 17/873,757

(22) Filed: Jul. 26, 2022

Related U.S. Application Data
(63) Continuation-in-part of application No. 17/591,468, filed on Feb. 2, 2022, now abandoned.
(60) Provisional application No. 63/144,487, filed on Feb. 2, 2021.

(51) Int. Cl. E06B 7/32; E06B 3/70; E06B 1/52; E06B 1/60

(52) U.S. Cl. CPC E06B 7/32; E06B 3/70; E06B 1/52; E06B 1/6015; E06B 2003/7044

(57) ABSTRACT

A package delivery door assembly is configured for being installed in an opening in a garage door. The assembly includes a frame having an outer peripheral planar portion configured to directly contact an outer surface of the garage door when the assembly is installed, and an inwardly extending flange portion configured to extend into the opening in the garage door when the assembly is installed. The assembly further includes two (or more) inner brackets. Each inner bracket has an inner planar portion and a ledge perpendicular to the inner planar portion. The ledges of the at least two inner brackets are configured to be coupled to the inwardly extending flange portion of the frame when the door assembly is installed, thereby avoiding additional holes being cut into the garage door. The assembly further includes a package delivery door hingedly attached to the frame.

### CROSS-REFERENCE TO RELATED APPLICATIONS

This application is a Continuation-In-Part of U.S. patent application Ser. No. 17/591,468 filed on Feb. 2, 2022, which claims priority to U.S. Provisional Patent Application No. 63/144,487 filed on Feb. 2, 2021, the contents of which are incorporated herein by reference.

### BACKGROUND

### Field of the Art

This disclosure relates to a package delivery door hidden in a garage door. In particular, this disclosure relates to a package delivery door that is easily installed in a garage door and provides a secure location for delivering a package.

### Discussion of the State of the Art

As online shopping and package deliveries to homes and businesses have increased, theft of these packages has also increased. Packages left outside of a home or business are susceptible to being stolen or damaged. For example, a package delivered to a home and left unattended on the front porch may be stolen, blown away by a strong wind, or damaged by the elements.

Currently available secure package delivery receptacles are intrusive, unsightly, and/or difficult to install. For example, package delivery doors built in to garage doors are too noticeable and are too heavy. Such built in package delivery doors interfere with normal operation of the garage door. Currently known package delivery doors installed in garage doors cause an imbalance in the garage door, meaning that one side of the garage door is heavier than the other. This imbalance causes the garage door to open in a lop-sided manner, which will damage or break the garage door. Currently known package delivery doors are also difficult to install, requiring several holes drilled into the garage door.

Thus, there is a need for a secure package delivery door that is relatively easy to install, lightweight, and aesthetically pleasing.

### SUMMARY

A package delivery door in accordance with the present invention is configured for being installed in a garage door in a manner that allows the package delivery door to blend in with the rest of the garage door so that the package delivery door is not noticeable. The package delivery door is part of a delivery door assembly that includes a frame configured for being attached to the interior of the garage door. The package delivery door is attached to the frame in a manner that allows the package delivery door to open relative to the garage door.

One of the advantages of the package delivery door assembly of the present invention is that it is easily installed and requires few modifications to an existing garage door. For example, in order to install the package delivery door assembly of the present invention in an existing garage door, a package delivery opening is cut into one of the panels of the garage door. Additionally, small openings are cut into an upper ledge on the interior side of the garage door panel. The package delivery door assembly includes clips that are positioned in the openings in the upper ledge of the garage door panel. The frame is then attached to the clips and the package delivery door is attached to the frame. As such, the assembly is removably coupled to the garage door.

Another advantage of the package delivery door assembly of the present invention is that it is lightweight and does not interfere with normal operation of the garage door. In particular, the package delivery door assembly is made of a lightweight, rigid material, such as aluminum, plastic, or the like.

In one embodiment of the present invention, a package delivery door assembly includes a frame having a top horizontal portion, a bottom horizontal portion, and two side vertical portions. Two bottom arms extend laterally outside of the frame adjacent to the bottom horizontal portion. Two top arms extend laterally outside of the frame adjacent to the top horizontal portion. Two clips are configured to attach to a panel of a garage door and to the two top arms. A package delivery door is hingedly attached to the frame.

In another embodiment of the present invention, a package delivery door assembly configured for being installed in an opening in a garage door includes a frame having an outer peripheral planar portion and an inwardly extending flange portion. The outer peripheral planar portion is configured to directly contact an outer surface of the garage door when the assembly is installed, and the inwardly extending flange portion is configured to extend into the opening in the garage door when the assembly is installed. The outer peripheral planar portion of the frame may be perpendicular to the inwardly extending flange portion of the frame. The frame may include a top frame portion parallel to a bottom frame portion, and a first side frame portion parallel to a second side frame portion. The top frame portion and the bottom frame portion may be perpendicular to the first side frame portion and the second side frame portion.

The package delivery door assembly further includes at least two inner brackets. Each inner bracket has an inner planar portion and a ledge perpendicular to the inner planar portion. The outer peripheral planar portion of the frame may be parallel to the inner planar portions of the at least two inner brackets when the assembly is installed. The inwardly extending flange portion of the frame may be parallel to the ledges of the at least two inner brackets when the assembly is installed. The ledges of the at least two inner brackets are configured to be coupled to the inwardly extending flange portion of the frame when the door assembly is installed. The package delivery door may include four inner brackets, and each one of the brackets may be coupled to one side of the inwardly extending flange portion of the frame. The at least two inner brackets may include a plurality of elongate holes disposed in the ledges of the at least two inner brackets. The inwardly extending flange portion of the frame may include a plurality of openings therethrough, and the openings may align with the elongate holes when the assembly is installed. The openings and elongate holes may be sized and shaped for a bolt to pass therethrough.

The package delivery door assembly further includes a package delivery door hingedly attached to the frame. The package delivery door assembly may further include an electronic lock for holding the package delivery door in a closed position relative to the frame. The assembly may be configured so that, when the assembly is installed, the garage door is positioned in a space between the outer peripheral planar portion of the frame and the inner planar portions of the at least two inner brackets.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIGS. 1A and 1B are perspective views of a garage door that includes a package delivery door in accordance with one embodiment of the present invention.

FIG. 2A illustrates the package delivery door assembly attached to an interior surface of a garage door, in accordance with one embodiment of the present invention.

FIG. 2B illustrates the frame of the package delivery door assembly, in accordance with one embodiment of the present invention.

FIGS. 3A and 3B are close up views of the bottom and top attachment points, respectively, between the frame and the interior surface of the garage door.

FIGS. 4A and 4B are top perspective and side perspective views, respectively, of a clip that is used to attach the frame to the garage door, in accordance with one embodiment of the present invention.

FIG. 5 is a perspective view of a package delivery door assembly in accordance with one embodiment of the present invention.

FIGS. 6A and 6B are front planar views of a package delivery door assembly in a closed configuration and an open configuration, respectively, in accordance with one embodiment of the present invention.

FIGS. 7A and 7B are top planar views of a package delivery door assembly in a closed configuration and an open configuration, respectively, in accordance with one embodiment of the present invention.

FIG. 8 is a side planar view of a package delivery door assembly in accordance with one embodiment of the present invention.

FIG. 9 is a rear perspective view of a package delivery door assembly in accordance with one embodiment of the present invention.

FIG. 10 is a perspective view of the outer frame and door portions of a package delivery door assembly in accordance with one embodiment of the present invention.

FIGS. 11A, 11B, and 11C are, respectively, a top plan view, a front plan view, and a side plan view of an inner bracket portion of a package delivery door assembly in accordance with one embodiment of the present invention.

FIG. 12 is a perspective view of an inner bracket portion of a package delivery door assembly having an electronic lock in accordance with one embodiment of the present invention.

### DETAILED DESCRIPTION

A package delivery door assembly of the present invention includes a frame and a delivery door attached to the frame via hinges. The frame is configured for being removably coupled to the interior portion of a panel of a garage door. The package delivery door assembly further includes clips that are configured to attach to the garage door panel, and the frame is configured to be coupled to the clips. In another embodiment, a package delivery door assembly includes an outer frame and inner brackets that attach to the outer frame with the garage door sandwiched therebetween. Because the inner brackets attach to the outer frame, additional holes in the garage door are avoided. The package delivery door assembly is relatively lightweight and easy to install. Since the assembly is removably coupled, rather than being fixedly coupled, the assembly can easily be removed and replaced, or removed and re-used in another garage door.

The invention is described by reference to various elements herein. It should be noted, however, that although the various elements of the inventive apparatus are described separately below, the elements need not necessarily be separate. The various embodiment may be interconnected and may be cut out of a singular block or mold. The variety of different ways of forming an inventive apparatus, in accordance with the disclosure herein, may be varied without departing from the scope of the invention.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Overview

The apparatus of the present invention is a delivery door assembly for installation in a garage door. The delivery door assembly provides a secure way for a package, parcel, mail, or other item to be delivered to a home or office. The delivery door assembly includes a frame that is installed on the interior of the garage door, and a delivery door that is hingedly attached to the frame and accessible from the exterior of the garage door. The delivery door assembly of the present invention is advantageously lightweight and easy to install. Another advantage of the package delivery door assembly is that it is easily removed and replaced or re-used in another garage door.

### Apparatus

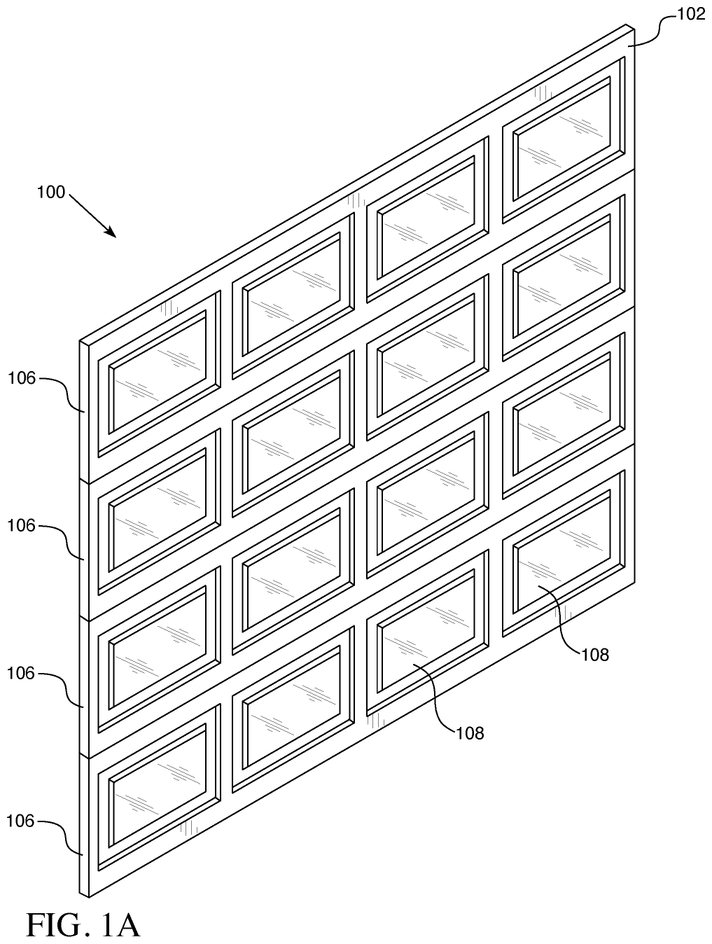

FIGS. 1A and 1B illustrate the inventive apparatus 100 in accordance with an embodiment of the invention. In particular, FIGS. 1A and 1B illustrate a garage door 102 that includes a hidden package delivery door 104. As shown in FIG. 1A, the garage door 102 in accordance with the present invention appears to be a conventional garage door. Similar to conventional garage doors, the garage door 102 of the present invention includes a plurality of horizontal panels 106 coupled to each other with hinges on the inside of the garage door 102. For example, the garage door 102 may include four panels 106, and each panel 106 may include four decorative sub-panels 108.

As shown in FIG. 1B, one of the decorative sub-panels 108 of the garage door 102 is replaced with the package delivery door 104. The package delivery door 104 is preferably the same size, shape, and color of the decorative sub-panels 108 so that the package delivery door 104 is disguised as being part of the garage door 102. That is, when the package delivery door 104 is closed, as shown in FIG. 1A, the garage door 102 appears to be a standard garage door. It will be readily understood by one of ordinary skill in the art that other sizes and styles of garage doors are possible with the present invention. For example, the hidden package delivery door 104 may be incorporated into a garage door for a two-car garage that is twice the width of the garage door 102 shown in FIGS. 1A and 1B. In another example, the hidden package delivery door 104 may be incorporated into a garage door that does not have decorative sub-panels, but rather has flat panels. Regardless of the size or style of the garage door, the hidden package delivery door 104 may be installed and camouflaged to blend in with the rest of the door.

While the package delivery door 104 depicted in FIGS. 1A and 1B is the same size as one of the decorative sub-panels 108, one of ordinary skill in the art will readily understand that other sizes are possible for the package delivery door 104. For example, the package delivery door 104 may replace two of the decorative sub-panels 108, thus having a width that is twice that of the package delivery door 104 depicted in FIGS. 1A and 1B.

As shown in FIG. 1B, the hidden package delivery door 104 opens outward towards the outside of the garage. In another embodiment, the hidden package delivery door 104 may be configured to open inward toward the inside of the garage. Further, it will be well understood that, while the package delivery door 104 is intended for receiving package deliveries in a safe, secure manner, any other items may be delivered safely into the garage through the package delivery door 104. Still further, it will be appreciated by one of ordinary skill in the art that the package delivery door 104 may be located anywhere in the garage door 102. For example, the package delivery door 104 may alternatively be incorporated into the bottom panel 106 or one of the upper panels 106, and may replace any one or more of the decorative sub-panels 108.

The hidden package delivery door 104 may be opened and closed using any known mechanism. For example, the package delivery door 104 may be manually opened and closed by manually pushing and pulling the package delivery door 104. In another example, the package delivery door 104 may be in communication with a key pad mounted outside the garage and may be opened and closed by entering a code into the keypad. In yet another example, the package delivery door 104 may be opened and closed using a key, a fob, an app on a mobile device, a motion sensor, or the like. The package delivery door 104 may be configured to automatically close after it has been open for a predetermined amount of time.

The garage door 102 may be manufactured to include the hidden package delivery door 104, or an existing garage door 102 may be modified to include the hidden package delivery door 104. Since the hidden package delivery door 104 is easy to install, an existing garage door may easily be retrofitted to include the hidden package delivery door 104.

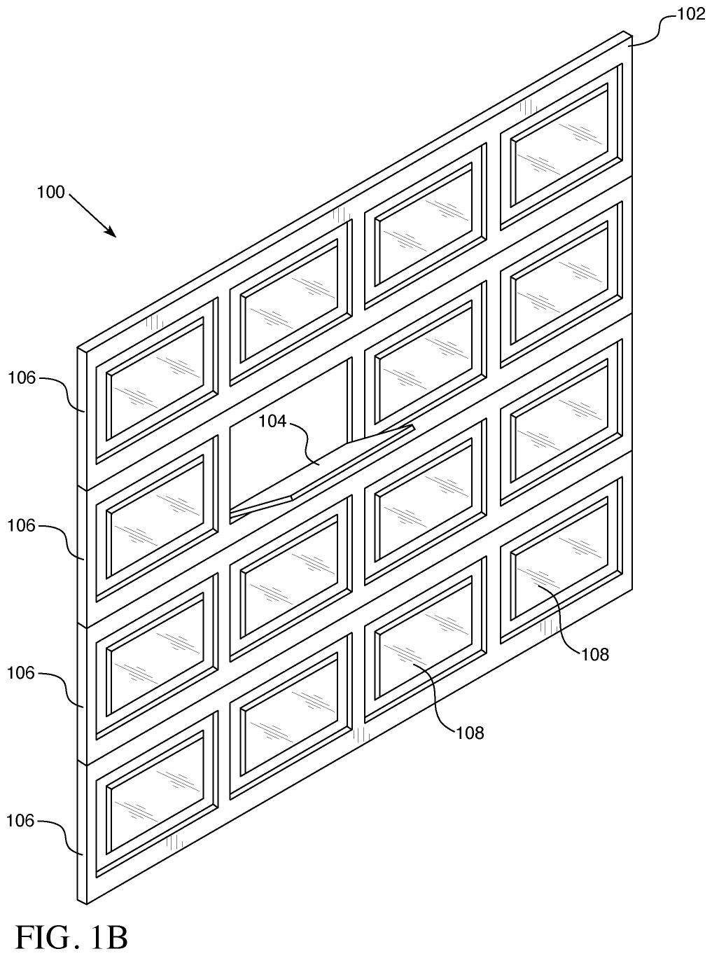

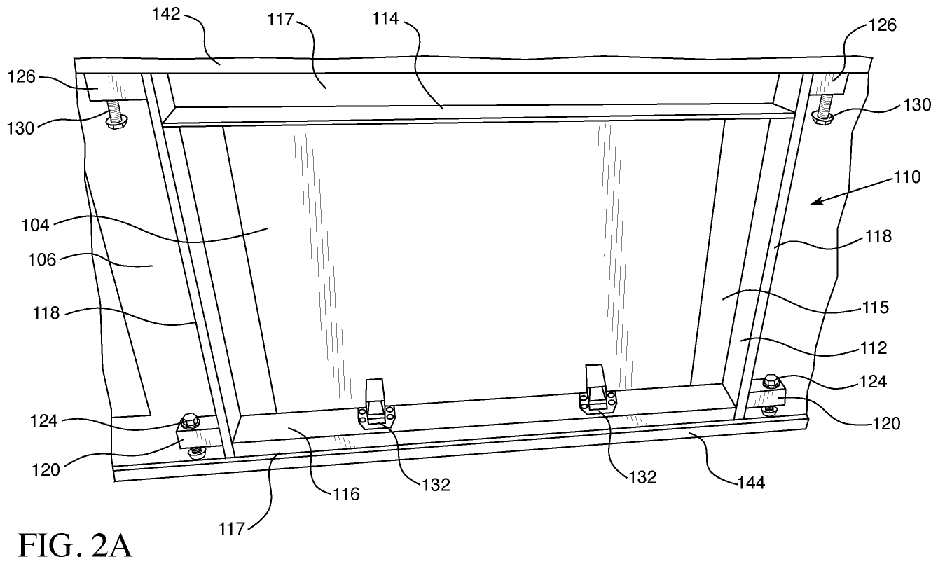

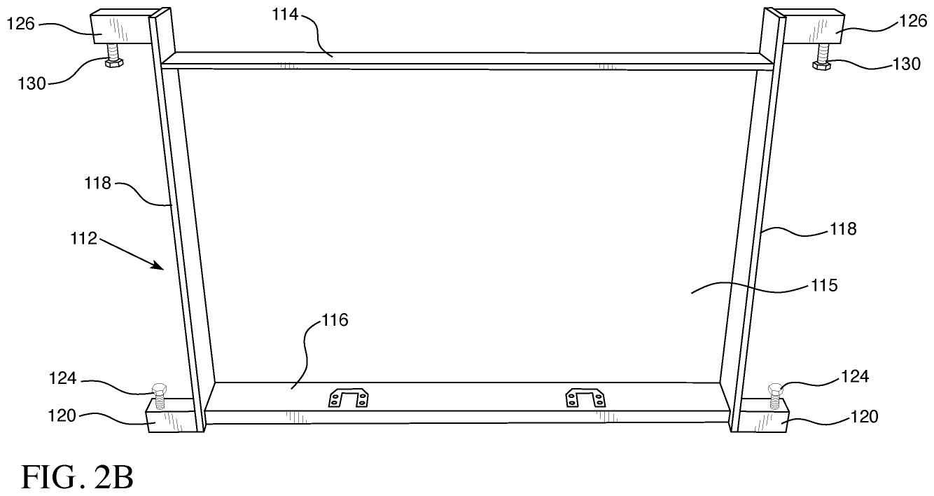

The hidden package delivery door 104 is part of a package delivery door assembly 110 that includes a frame 112 to which the package delivery door 104 is hingedly attached, as shown in FIG. 2A. The frame 112 by itself is depicted in FIG. 2B. The frame 112 includes a top horizontal portion 114, a bottom horizontal portion 116 parallel to the top portion 114, and two vertical side portions 118 that are parallel to each other. The top portion 114, bottom portion 116, and side portions 118 frame a package delivery opening 115. The side portions 118 of the frame 112 extend upwards relative to the top portion 114 and downwards relative to the bottom portion 116 in order to create space 117 between the top portion 114 and the garage door panel 106 and between the bottom portion 116 and the garage door panel 106. The frame 112 further includes bottom arms 120 that extend laterally outside of the frame 112 adjacent to the bottom horizontal portion 116. The bottom arms 120 extend parallel to the bottom portion 116 of the frame 112 and perpendicular to the side portions 118. The bottom arms 120 includes threaded openings through which threaded bolts 124 may extend. The frame 112 further includes top arms 126 that extend laterally outside of the frame 112 adjacent to the top portion 114 of the frame 112. The top arms 126 extend in a direction that is parallel to the top portion 114 and perpendicular to the side portions 118. Similar to the bottom arms 120, the top arms 126 include threaded through holes 128 (see FIG. 3B) that accommodate threaded bolts 130 extending therethrough.

The package delivery door 104 is depicted in FIG. 2A as being coupled to the bottom portion 116 of the frame 112 via hinges 132. It will be readily apparent to one of ordinary skill in the art that the package delivery door 104 may alternatively be attached to the top portion 114 of the frame or to one of the side portions 118 of the frame 112. Further, it will be readily apparent that the package delivery door 104 may be attached to the frame 112 with any type of hinge or other attachment mechanisms around which the package delivery door 104 is able to pivot between an open position and a closed position.

As shown in FIG. 2A, the frame 112 is attached directly to the interior of the garage door 102. In particular, the frame 112 is positioned between an upper ledge 142 and a lower ledge 144 of the interior surface of the garage door panel 106.

The threaded bolts 124 extending through the bottom arms 120 are in contact with the lower ledge 144 of the garage door panel 106 to create an interference fit between the bolts 124 and the lower ledge 144 of the garage door panel 106. This interference fit is depicted in more detail in FIG. 3A. A cap 150 having a rubber shell or cover 152 may be disposed between the bolts 124 and the lower ledge 144 in order to prevent the frame 112 from slipping out of place. However, it will be readily understood by one of ordinary skill in the art that the bolts 124 may be in direct contact with the lower ledge 144, or that a different intervening non-slip material may be disposed between the bolts 124 and the lower ledge 144.

The threaded bolts 130 extending through the top arms 126 are used to attach the frame 112 to the upper ledge 142 of the garage door panel 106. With reference to FIG. 3B, in one embodiment, a clip 160 is disposed in an opening 146 formed in the upper ledge 142 of the garage door panel 106. The clip 160 is configured to attach to the threaded bolt 130. In this manner, the frame 112 is removably attached to the upper ledge 142 of the garage door panel 106 via threaded bolts 130 and clips 160.

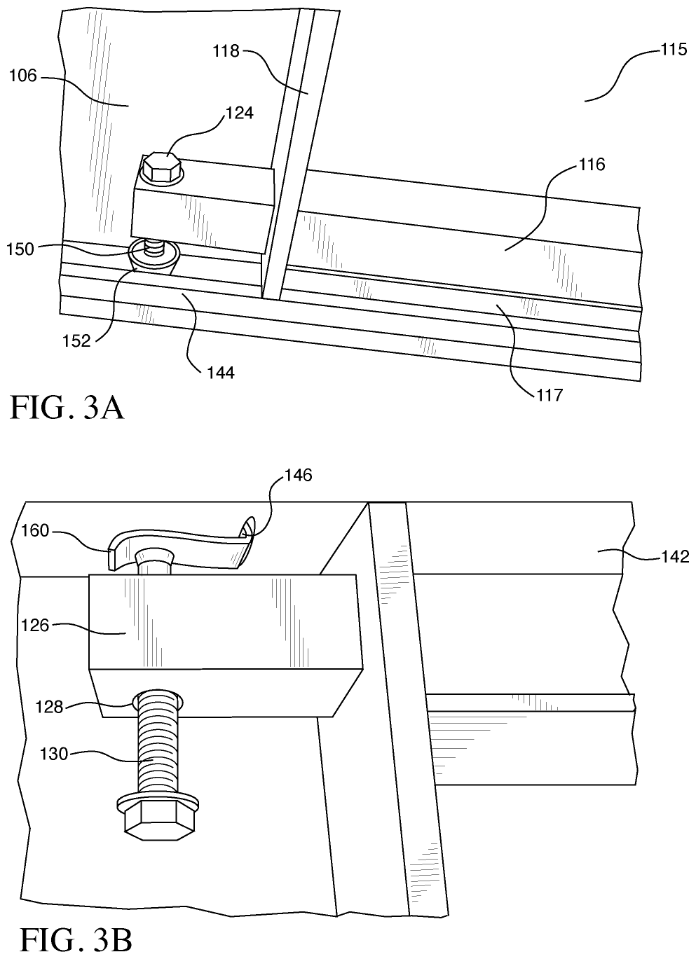

One of the clips 160 is depicted in more detail with reference to FIGS. 4A and 4B. The clip 160 is generally U-shaped and includes a top arm 164, lower arm 166, and a side surface 168 that connects the top arm 164 and lower arm 166 together. A threaded opening 162 protrudes from the lower arm 166 and is configured to couple to the threaded bolts 130. When installed, the top arm 164 is disposed on the top surface of the garage door panel upper ledge 142, the lower arm 166 is disposed under the upper ledge 142, and the side surface 168 is disposed in the opening 146 formed through the upper ledge 142.

The package delivery door assembly 110 may be provided as a kit to be installed on an existing garage door. The package delivery door assembly 110 is relatively easy to install. One of the advantages of the package delivery door assembly 110 is that it is not fixedly coupled to the garage door. In other words, the assembly 110 is removably coupled to the garage door so that the assembly 110 is easy to install and easy to remove. If the assembly 110 becomes damaged, it can easily be removed and replaced. Similarly, the assembly 110 can easily be removed and reused in another garage door.

In order to install the package delivery door assembly 110 in an existing garage door, the openings 146 and 115 are first cut into the garage door panel 106. That is, two openings 146 are cut into the upper ledge 142 of the interior of the garage door panel 106, and a package delivery opening 115 is cut into the garage door panel 106. Next, clips 160 are positioned in the openings 146 in the upper ledge 142 so that the top arms 164 of the clips 160 are positioned on top of the ledge 142, the lower arms 166 of the clips 160 are positioned on the underside of the ledge 142, and the side surfaces 168 of the clips 160 extend through the openings 146. Next, the frame 112 is positioned against the garage door panel 106 so that the package delivery opening 115 of the frame 112 is aligned with the package delivery opening cut into the garage door panel 106. After the frame 112 is correctly positioned, the bolts 130 and 124 are threaded through the upper arms 126 and lower arms 120, respectively, of the frame 112. The bolts 130 are tightened until the bolts 130 are attached to the threaded openings 162 protruding from the clips 160. The bolts 124 are tightened until an interference fit is achieved between the bolts 124 and the lower ledge 144 of the garage door panel 106. Caps 150 having rubber covers 152 may optionally be disposed between the distal end of the bolts 124 and the upper surface of the lower ledge 144. The kit may be provided with the package delivery door 104 already attached to the frame 112. Alternatively, if the door 104 is provided separately, the last step in the installation process is for the package delivery door 104 to be attached to the frame 112 after the frame 112 is attached to the garage door panel 106.

Another advantage of the delivery door assembly 110 is that the assembly 110 is relatively lightweight and does not interfere with operation of the garage door. For example, the delivery door assembly is made of a rigid lightweight material, such as aluminum, plastic, or the like, or combinations of these materials.

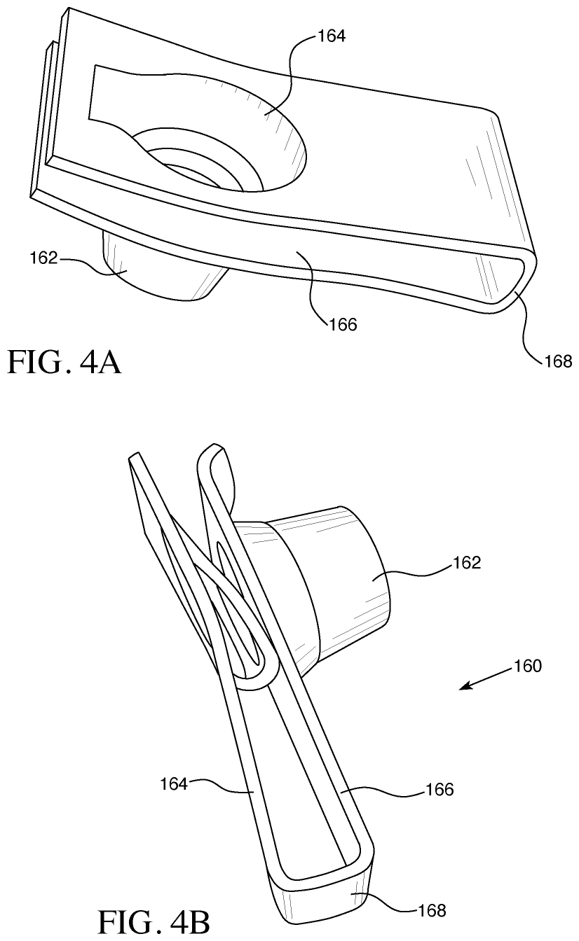

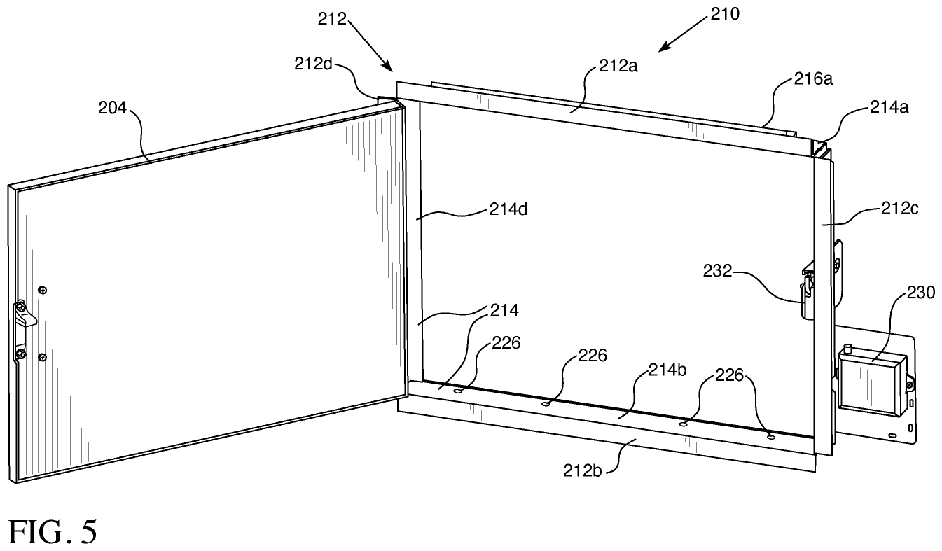

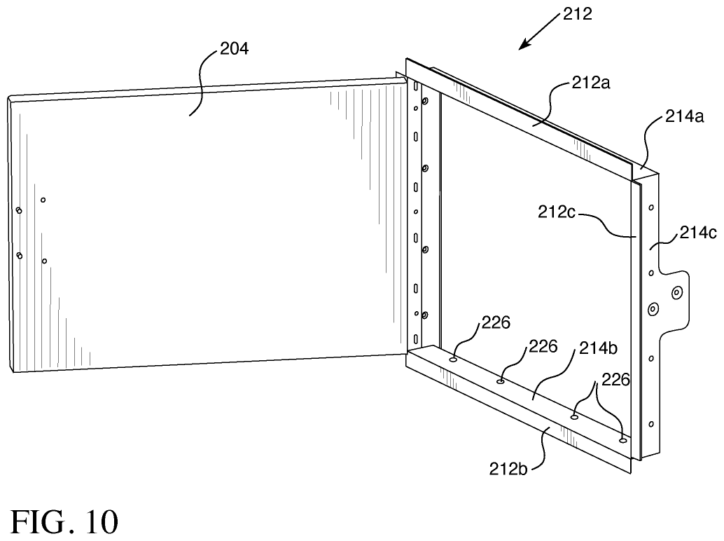

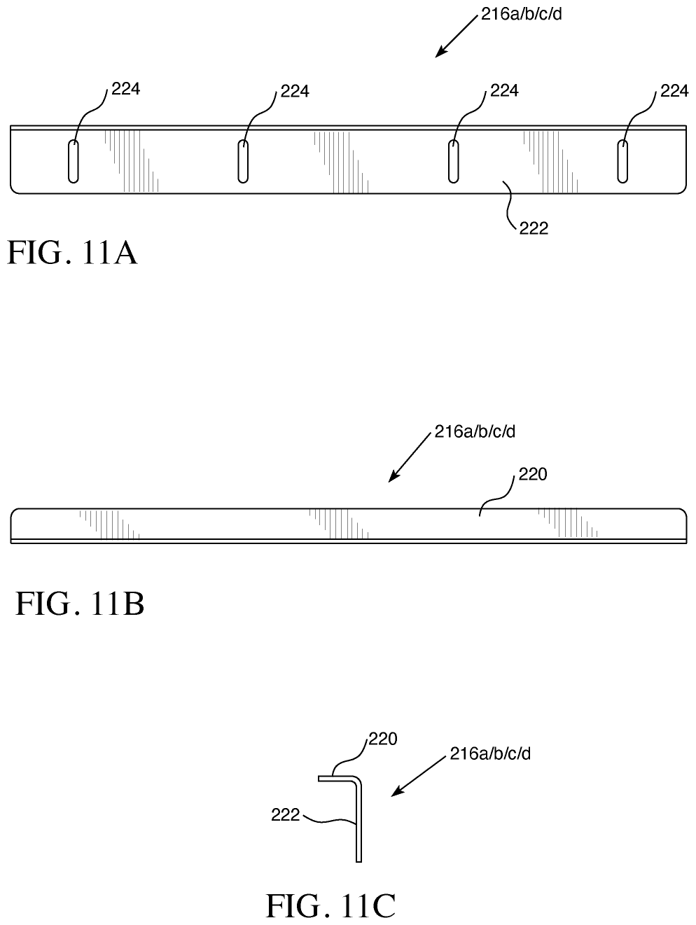

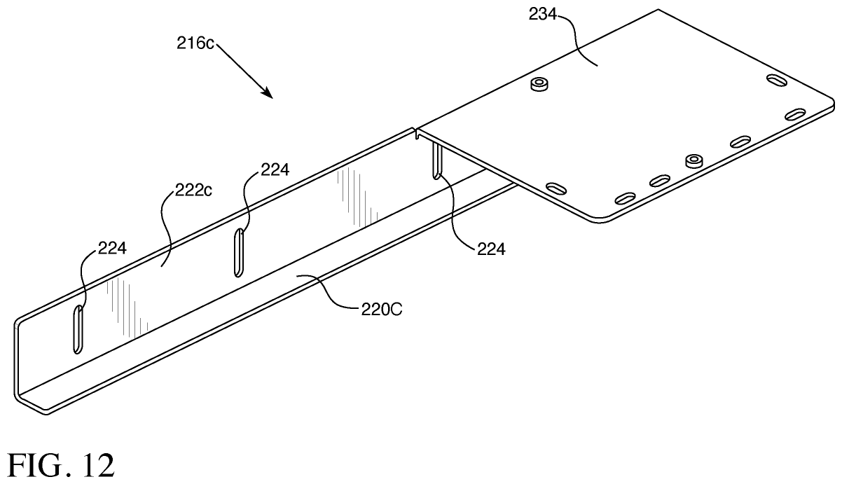

In another example, the hidden package delivery door is part of a package delivery door assembly 210 that includes a frame 212 to which the package delivery door 204 is hingedly attached, and inner brackets 216 for holding the frame 212 in place. The assembly is depicted in FIGS. 5-9. The frame 212 is depicted in more detail in FIG. 10. The inner brackets 216 are depicted in more detail in FIGS. 11A-12.

The frame 212 with the door 204 attached thereto is positioned at the front surface of the garage door. Although the door 204 is depicted as opening outward and sideways to the left, it will be readily understood by one of ordinary skill in the art that the door 204 may alternatively be configured to open sideways to the right, downwards (similar to the previous embodiment), or may be configured to open inwards.

When installed, the frame 212 is in direct contact with the front surface of the garage door. The frame 212 includes an outer peripheral planar portion that is in direct contact with the front surface of the garage door. The outer peripheral planar portion includes a top frame portion 212a, a bottom frame portion 212b, a first side frame portion 212c, and a second side frame portion 212d. All of the outer peripheral planar portions 212a, 212b, 212c, 212d are in the same plane.

The frame 212 further includes an inwardly extending flange portion 214 that extends into the package delivery opening in the garage door. The inwardly extending flange portion 214 has a top flange portion 214a that is directly coupled to the top frame portion 212a, a bottom flange portion 214b that is directly coupled to the bottom frame portion 212b, a first side flange portion 214c that is directly coupled to the first side frame portion 212c, and a second side flange portion 214d that is directly coupled to the second side frame portion 212d. The outer frame 212 and the inwardly extending flange portion 214 are fixedly coupled to each other and are preferably made from a unitary piece. The inwardly extending flange portion 214 is perpendicular to the outer frame 212.

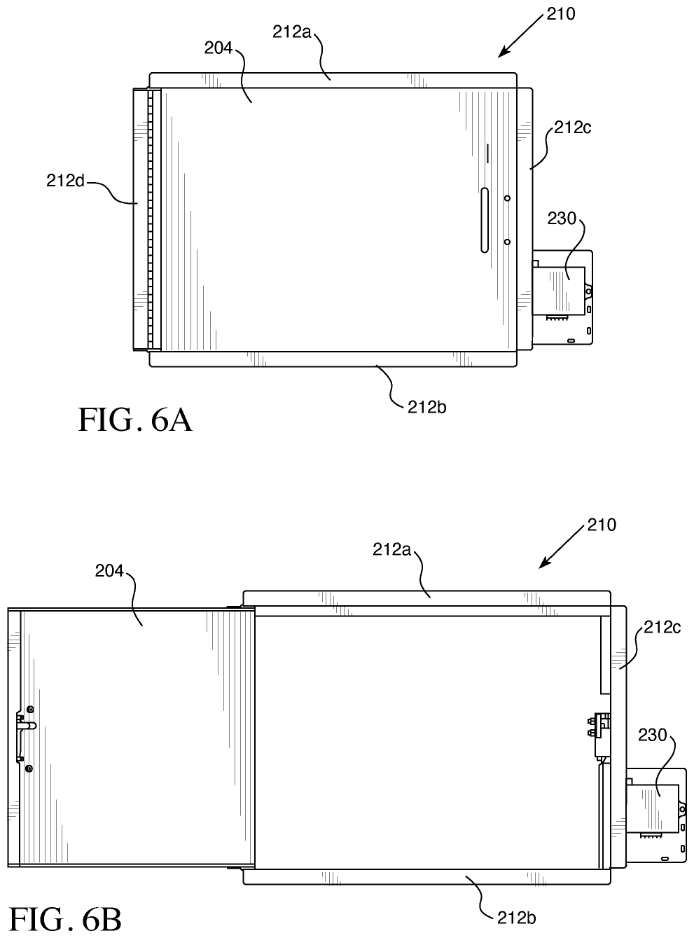

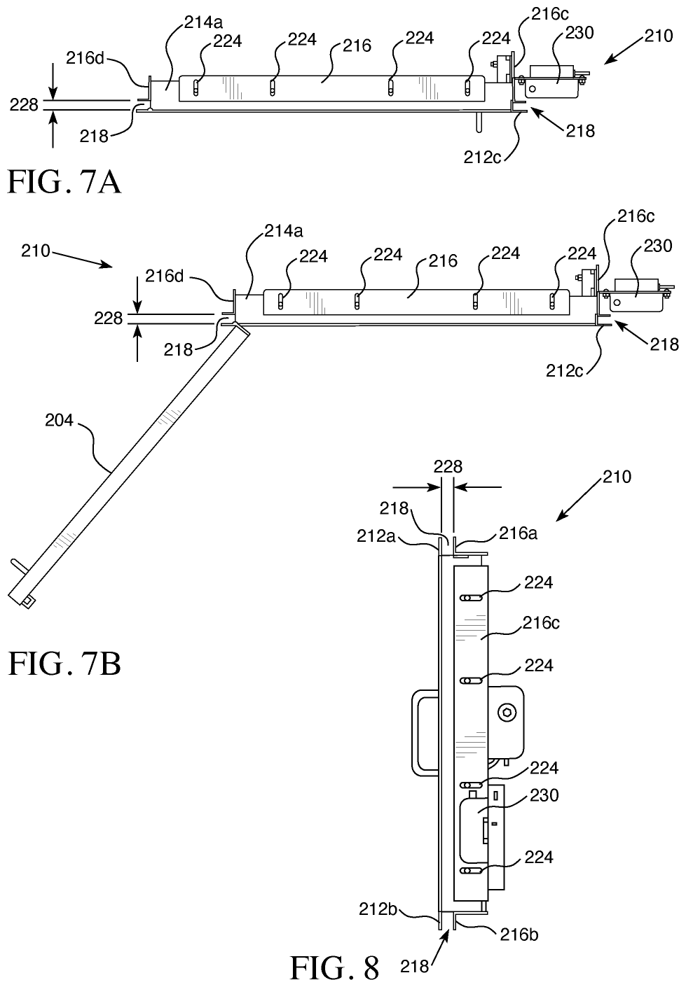

The door assembly 210 further includes inner brackets 216a, 216b, 216c, and 216d that are positioned on the inside of the garage door. With reference to FIGS. 7A, 7B, and 8, the garage door is disposed in the space 218 between the outer frame 212 and the inner brackets 216a, 216b, 216c, and 216d. The outer frame 212 and the inner brackets 216a, 216b, 216c, and 216d are then attached to each other with the garage door sandwiched therebetween. In this manner, the bolts that attach the door assembly 210 to the garage door do not actually pass through the garage door. As such, installation of the door assembly 210 does not require additional holes to be made through the garage door. Installation of the door assembly 210 only requires one opening (a package delivery opening) to be cut in the garage door.

The inner brackets 216a, 216b, 216c, and 216d are discussed in more detail with reference to FIGS. 11A-11C, which depict one of the brackets 216a, 216b, 216c, and 216d. The brackets 216a, 216b, 216c, and 216d are substantially identical to each other, except that the side brackets 216c and 216d may be shorter than the top bracket 216a and the bottom bracket 216b. However, it will be readily apparent to one of ordinary skill in the art that the brackets 216a, 216b, 216c, and 216d may have any desired dimensions. For example, the top bracket 216a and bottom bracket 216b may be shorter than the side brackets 216c and 216d, or the brackets 216a, 216b, 216c, and 216d may all have the same lengths. Each one of the inner brackets 216a, 216b, 216c, and 216d includes a planar portion 220 that is in direct contact with the inside surface of the garage door when the door assembly 210 is installed. As such, the planar portions 220 are all on the same plane and are parallel to the outer frame portions 212a, 212b, 212c, 212d. When the door assembly 210 is installed, the plane in which the outer frame portions 212a, 212b, 212c, 212d lie is parallel to the plane of the garage door, and parallel to the plane in which the planar portions 220 lie. The garage door is positioned in the space 218 between the outer frame portions 212a, 212b, 212c, 212d and the inner planar portions 220. However, there are no bolts, screws, or other attachment mechanisms that pass through the outer frame portions 212a, 212b, 212c, 212d, the garage door, and the inner planar portions 220. As such, damage to the garage door is minimized and installation is easier compared to other door assemblies that require the frame to be bolted to the garage door.

As shown in FIGS. 11A-11C, each one of the inner brackets 216a, 216b, 216c, and 216d further includes a ledge 222 that is directly coupled to, and perpendicular to, the inner planar portions 220. The ledge 222 and the respective inner planar portions 220 are preferably made from a unitary piece.

To hold the door assembly 210 in place in the garage door, the inwardly extending flange portion 214 of the outer frame 212 is coupled to the ledge 222 of the brackets 216a, 216b, 216c, and 216d while the garage door is sandwiched between the inner planar portions 220 and the outer frame portions 212a, 212b, 212c, 212d.

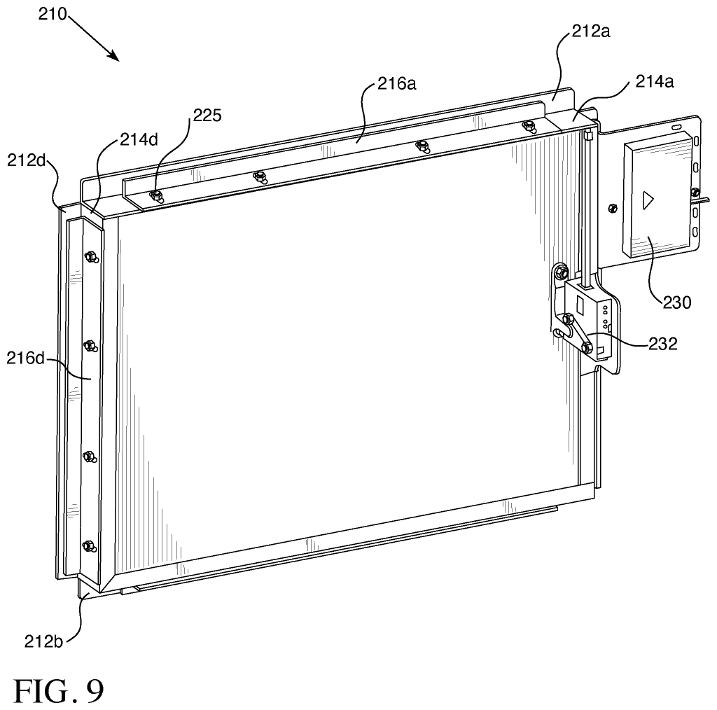

Each one of the ledges 222 includes a plurality of elongate openings 224 through which an attachment member 225 (shown in FIG. 9) may pass. The attachment member 225 may be a screw, bolt, rivet, or other similar attachment member. The attachment member 225 passes through the elongate opening 224 and openings 226 (shown in FIGS. 5 and 10) in the inwardly extending flange portion 214 of the outer frame 212. The elongate openings 224 allow for adjustment of the width 228 of the space 218 between the inner planar portions 220 and the outer frame portions 212a, 212b, 212c, 212d. As such, the door assembly 210 is configured to accommodate garage doors of varying thicknesses.

In one example, the door 204 is locked with an electronic lock or a smart lock. In this example, a compartment 230 may be attached to one of the inner brackets 216c. The compartment 230 is configured to hold a battery, remote receiver, and other electronics necessary for a smart lock or other electronic lock. The components held in the compartment 230 are in communication with the latch 232 that holds the door 204 in the closed position. The electronic lock is advantageous for allowing a user (e.g., a delivery person) to open the door 204 from outside the garage by inputting a code into a keypad that is in wireless communication with the components in the compartment 230, or by scanning a barcode or QR code. The user can then deposit the package through the opening in the garage door and close the door 204. The door 204 may be configured to close automatically upon being open for a predetermined amount of time. It will be well understood by one of ordinary skill in the art that the door 204 may alternatively be locked or held in the closed position using a conventional latch, deadbolt, or the like.

In one example, the inner bracket 216c to which the compartment 230 may be attached is shown in FIG. 12. The inner bracket 216c includes the inner planar portion 220c, the ledge 222c, the elongate openings 224, and a support 234 to which the compartment 230 may be attached.

In order to install the door assembly 210, a package delivery opening is cut into a garage door panel. The opening is square or rectangular in shape and is large enough to accommodate the outer frame 212. Next, the outer frame is positioned against the outer surface of the garage door so that the outer frame portions 212a, 212b, 212c, 212d are in direct contact with the outer surface of the garage door and the inwardly extending flange portion 214 extends into the opening in the garage door panel. Next, the brackets 216a, 216b, 216c, and 216d are positioned adjacent to the inside surface of the garage door so that the inner planar portions 220 are in direct contact with the inside surface of the garage door and the ledge 222 is adjacent to the inwardly extending flange portion 214 of the outer frame 212. As such, the portion of the garage door that surrounds the package delivery opening cut into the garage door panel is sandwiched between the inner planar portions 220 and the outer frame portions 212a, 212b, 212c, 212d. The ledges 222 of the inner brackets 216a, 216b, 216c, and 216d are coupled to the inwardly extending flange 214 of the outer frame in order to hold the door assembly 210 in place.

The door assembly 210 is not limited to having four inner brackets 216a, 216b, 216c, and 216d. In an alternative example, the door assembly 210 includes an inner frame rather than four separate brackets. In yet another example, the door assembly 210 includes only two or three brackets and is thus held in place on only two or three sides, respectively, of the outer frame 212.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A package delivery door assembly configured for being installed in an opening in a garage door, wherein the package delivery door assembly comprises:
a frame having an outer peripheral planar portion and an inwardly extending flange portion, wherein the outer peripheral planar portion is configured to directly contact an outer surface of the garage door when the assembly is installed, and wherein the inwardly extending flange portion is configured to extend into the opening in the garage door when the assembly is installed;
at least two inner brackets, each inner bracket having an inner planar portion and a ledge perpendicular to the inner planar portion, wherein the ledges of the at least two inner brackets are configured to be coupled to the inwardly extending flange portion of the frame when the door assembly is installed; and
a package delivery door hingedly attached to the frame.

2. The package delivery door assembly of claim 1, wherein the at least two inner brackets comprise four inner brackets, wherein each one of the brackets is coupled to one side of the inwardly extending flange portion of the frame.

3. The package delivery door assembly of claim 1, wherein the at least two inner brackets comprise a plurality of elongate holes disposed in the ledges of the at least two inner brackets.

4. The package delivery door assembly of claim 3, wherein the inwardly extending flange portion of the frame comprises a plurality of openings therethrough, and wherein the openings align with the elongate holes when the assembly is installed, and wherein the openings and elongate holes are sized and shaped for a bolt to pass therethrough.

5. The package delivery door assembly of claim 1, further comprising an electronic lock for holding the package delivery door in a closed position relative to the frame.

6. The package delivery door assembly of claim 1, wherein the outer peripheral planar portion of the frame is perpendicular to the inwardly extending flange portion of the frame.

7. The package delivery door assembly of claim 1, wherein the frame comprises a top frame portion parallel to a bottom frame portion, and a first side frame portion parallel to a second side frame portion, wherein the top frame portion and the bottom frame portion are perpendicular to the first side frame portion and the second side frame portion.

8. The package delivery door assembly of claim 1, wherein the assembly is configured so that, when the assembly is installed, the garage door is positioned in a space between the outer peripheral planar portion of the frame and the inner planar portions of the at least two inner brackets.

9. The package delivery door assembly of claim 1, wherein the outer peripheral planar portion of the frame is parallel to the inner planar portions of the at least two inner brackets when the assembly is installed.

10. The package delivery door assembly of claim 1, wherein the inwardly extending flange portion of the frame is parallel to the ledges of the at least two inner brackets when the assembly is installed.
